(19) United States
(12) Patent Application Publication
(10) Pub. No.: US 2004/0060178 A1
(43) Pub. Date: Apr. 1, 2004

(54) Circular saw

(76) Inventors: Mark Willer, Brookfield, WI (US); Christopher Berg, Milwaukee, WI (US); Dale Di Iulio, Grafton, WI (US); Mark Hickok, Waukesha, WI (US); Chris Seward, Sussex, WI (US); Steven Hachey, Waukesha, WI (US)

Correspondence Address: MICHAEL BEST & FRIEDRICH, LLP, 100 E WISCONSIN AVENUE, MILWAUKEE, WI, 53202, US

(21) Appl. No.: 10/672,717

(22) Filed: Sep. 26, 2003

Related U.S. Application Data
(60) Provisional application No. 60/415,081, filed on Oct. 1, 2002.

(51) Int. Cl. B27B 9/00

(52) U.S. Cl. 30/391

(57) ABSTRACT

Power tools, such as, saws and circular saws, and methods. In some constructions and in some aspects, a saw includes a housing, a motor, a cover, and a quick-locking member operable to releasably lock the cover to the housing without tools. In some constructions and in some aspects, a saw includes a housing, a motor, a first cover connected to the housing, the first cover at least partially covering a saw blade, and a second cover selectively connectable to the housing, the second cover at least partially covering the first cover and at least partially covering the saw blade. In some constructions and in some aspects, a method of disassembling a saw including moving a locking member from a first position to a second position without the use of tools, and removing a cover from a housing to at least partially uncover the saw blade.

### RELATED APPLICATIONS

The present application claims the benefit of prior-filed, co-pending provisional patent application Serial No. 60/415,081, filed Oct. 1, 2002.

### FIELD OF THE INVENTION

The present invention relates to power tools and, more particularly, to circular saws.

### BACKGROUND OF THE INVENTION

Generally, circular saws include a housing and a motor supported by the housing. The motor is operable to drive a saw blade to cut work pieces made of a variety of materials, such as, for example, metal, fiber and wood.

### SUMMARY OF THE INVENTION

The present invention provides a power tool, such as a saw or a circular saw, which substantially alleviates one or more problems with existing power tools, saws or circular saws. In some constructions and in some aspects, the invention provides a circular saw with a removable blade cover and a quick-connect, tool-less locking assembly to selectively lock the cover to a housing of the circular saw. In some aspects and in some constructions, the invention provides a removable blade cover and a fixed blade cover.

In some constructions and in some aspects, the invention provides a saw including a housing, a motor supported by the housing and operable to drive a saw blade, a cover selectively connectable to the housing, the cover at least partially covering the saw blade when the cover is connected to the housing, and a quick-locking member connected to one of the housing and the cover and engageable with the other of the housing and the cover to selectively lock the cover to the housing without the use of tools.

Also, in some constructions and in some aspects, the invention provides a method of disassembling a saw, the saw including a housing, a motor supported by the housing and operable to drive a saw blade, a cover connectable to the housing and at least partially covering the saw blade when the cover is connected to the housing, and a locking member connected to one of the housing and the cover and engageable with the other of the housing and the cover to selectively lock the cover to the housing, the method including the acts of moving the locking member from a first position, in which the locking member engages the one of the housing and the cover to lock the cover to the housing, to a second position, in which the cover is not locked to the housing, without the use of tools, and removing the cover from the housing to at least partially uncover the saw blade.

In addition, in some constructions and in some aspects, the invention provides a saw including a housing, a motor supported by the housing and operable to drive a saw blade, a first cover connected to the housing, the first cover at least partially covering the saw blade, and a second cover selectively connectable to the housing, the second cover at least partially covering the first cover and at least partially covering the saw blade when the second cover is connected to the housing.

Further, in some constructions and in some aspects, the invention provides a saw including a housing, a motor, a cover, and a quick-locking member operable to releasably lock the cover to the housing without tools.

Independent features and independent advantages of the invention will become apparent to those skilled in the art upon review of the following detailed description, claims and drawings.

### BRIEF DESCRIPTION OF THE DRAWINGS

FIG. 1 is a front perspective view of a power tool, such as a circular saw, embodying aspects of the present invention.

FIG. 2 is another front perspective view of the circular saw of FIG. 1, shown with a latch of the circular saw in an engaged position.

FIG. 3 is another front perspective view of the circular saw of FIG. 1, shown with the latch of the circular saw in a disengaged position.

FIG. 4 is a partially exploded front perspective view of the saw of FIG. 1, shown with a removable cover removed.

FIG. 5 is another partially exploded front perspective view of the saw of FIG. 1, shown with the removable cover removed.

FIG. 6 is a partially exploded rear perspective view of the saw of FIG. 1, shown with the removable cover removed to show the inside of the removable cover.

FIG. 7 is another partially exploded front perspective view of the saw of FIG. 1, shown with the removable cover removed to show an inner cover of the circular saw.

FIG. 8 is an enlarged front perspective view of the saw of FIG. 1 showing the inner cover.

FIG. 9 is another rear perspective view of the saw of FIG. 1 showing a manual lower guard lever of the circular saw.

FIG. 10 is another front perspective view of the rear portion of the saw of FIG. 1, shown with the latch in the disengaged position.

FIG. 11 is an enlarged front perspective view of the latch of FIG. 10, taken from detail line 11-11.

FIG. 12 is another front perspective view of the rear portion of the saw of FIG. 1, shown with the latch in the engaged position.

FIG. 13 is an enlarged front perspective view of the latch of FIG. 12, taken from detail line 13-13.

FIG. 14 is a front perspective view of another construction of a circular saw embodying aspects of the present invention, shown with a latch of the circular saw in an engaged position.

FIG. 15 is another front perspective view of the circular saw of FIG. 14.

FIG. 16 is a front view of the circular saw of FIG. 14.

FIG. 17 is a rear perspective view of the circular saw of FIG. 14.

FIG. 18 is another rear perspective view of the circular saw of FIG. 14.

FIG. 19 is another rear perspective view of the circular saw of FIG. 14.

FIG. 20 is a rear view of the circular saw of FIG. 14.

FIG. 21 is a right side view of the circular saw of FIG. 14.

FIG. 22 is a left side view of the circular saw of FIG. 14.

FIG. 23 is a top view of the circular saw of FIG. 14.

FIG. 24 is a bottom view of the circular saw of FIG. 14.

FIG. 25 is a front perspective view of the circular saw of FIG. 14, shown with detail line 26-26.

FIG. 26 is an enlarged front perspective view of the circular saw of FIG. 14, shown with the latch in the engaged position and taken along detail line 26-26.

FIG. 27 is a front perspective view of the circular saw of FIG. 14, shown with detail line 28-28.

FIG. 28 is an enlarged front perspective view of the circular saw of FIG. 14, shown with the latch in a disengaged position and taken along detail line 28-28.

FIG. 29 is an exploded view of the latch of the circular saw of FIG. 14.

FIG. 30 is a partially exploded front perspective view of the circular saw of FIG. 14, shown with a removable cover of the circular saw removed.

FIG. 31 is a partially exploded rear perspective view of the circular saw of FIG. 14, shown with the removable cover of the circular saw removed.

FIG. 32 is a front perspective view of the circular saw of FIG. 14, shown without the removable cover.

FIG. 33 is another front perspective view of the circular saw of FIG. 14, shown without the removable cover.

FIG. 34 is a front view of the circular saw of FIG. 14, shown without the removable cover.

FIG. 35 is a rear perspective view of the circular saw of FIG. 14, shown without the removable cover.

FIG. 36 is another rear perspective view of the circular saw of FIG. 14, shown without the removable cover.

FIG. 37 is another rear perspective view of the circular saw of FIG. 14, shown without the removable cover.

FIG. 38 is a rear view of the circular saw of FIG. 14, shown without the removable cover.

FIG. 39 is a right side view of the circular saw of FIG. 14, shown without the removable cover.

FIG. 40 is a left side view of the circular saw of FIG. 14, shown without the removable cover.

FIG. 41 is a top view of the circular saw of FIG. 14, shown without the removable cover.

FIG. 42 is a bottom view of the circular saw of FIG. 14, shown without the removable cover.

FIG. 43 is a partially exploded front perspective view of the saw of FIG. 14, shown with an inner cover of the saw and the removable cover of the saw removed.

FIG. 44 is a front perspective view of the inner cover of the saw of FIG. 14.

Before at least one embodiment of the invention is explained in detail, it is to be understood that the invention is not limited in its application to the details of the construction and the arrangements of the components set forth in the following description or illustrated in the drawings. The invention is capable of other embodiments and of being practiced or being carried out in various ways. In addition, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

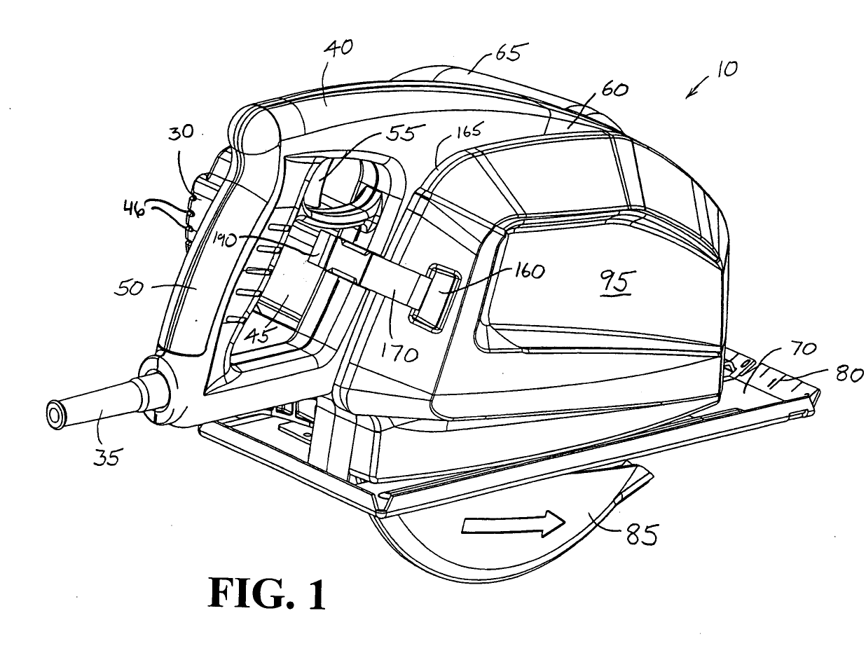

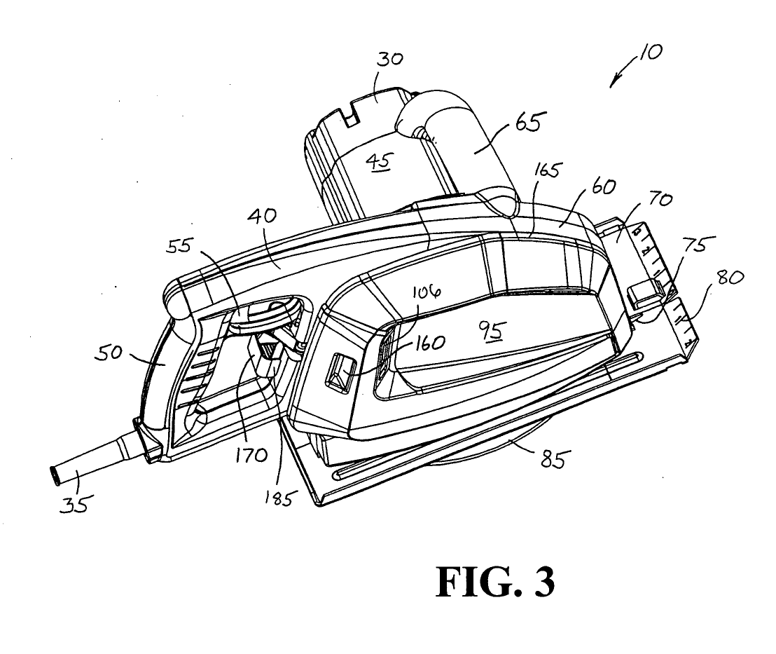

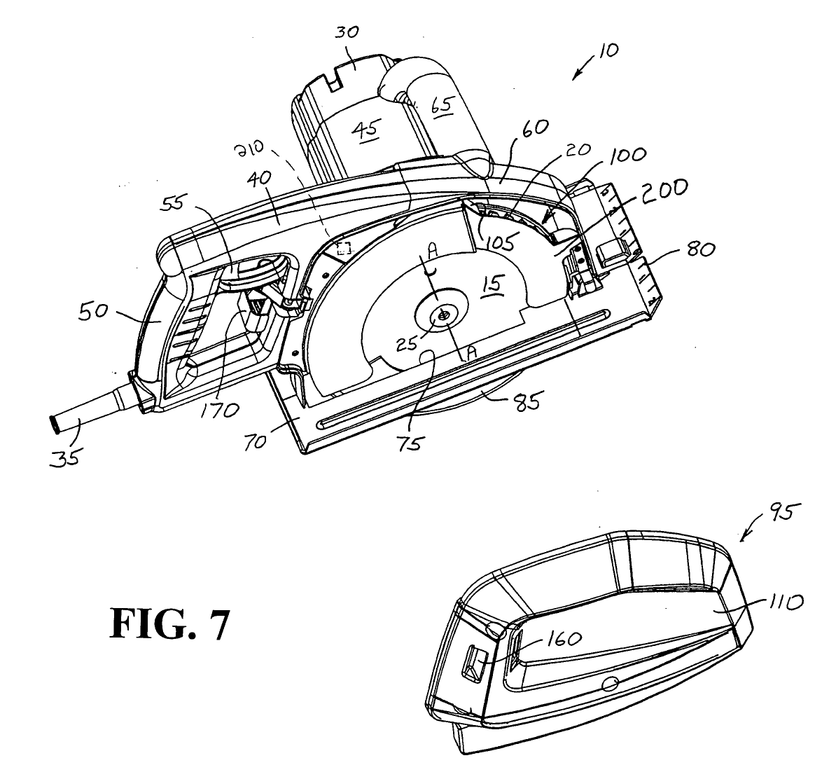

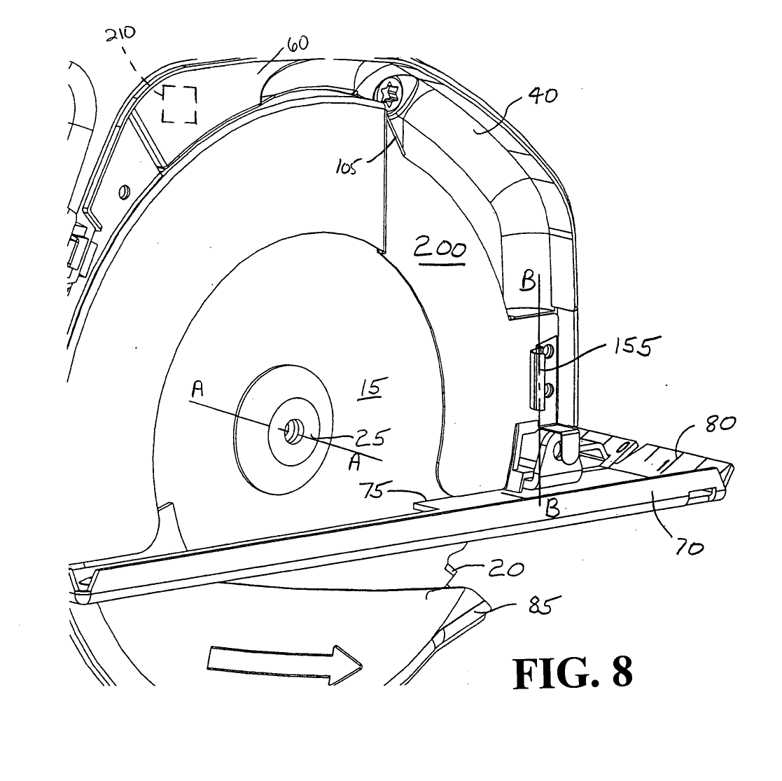

Referring to FIGS. 1-13, a power tool, such as a saw, a circular saw 10, etc., embodying aspects of the present invention is illustrated. In some constructions and in some aspects, the circular saw 10 is a metal cutting circular saw. In other aspects and other constructions, the circular saw 10 may be operable to cut work pieces of other material, such as, for example, wood, fiber, etc.

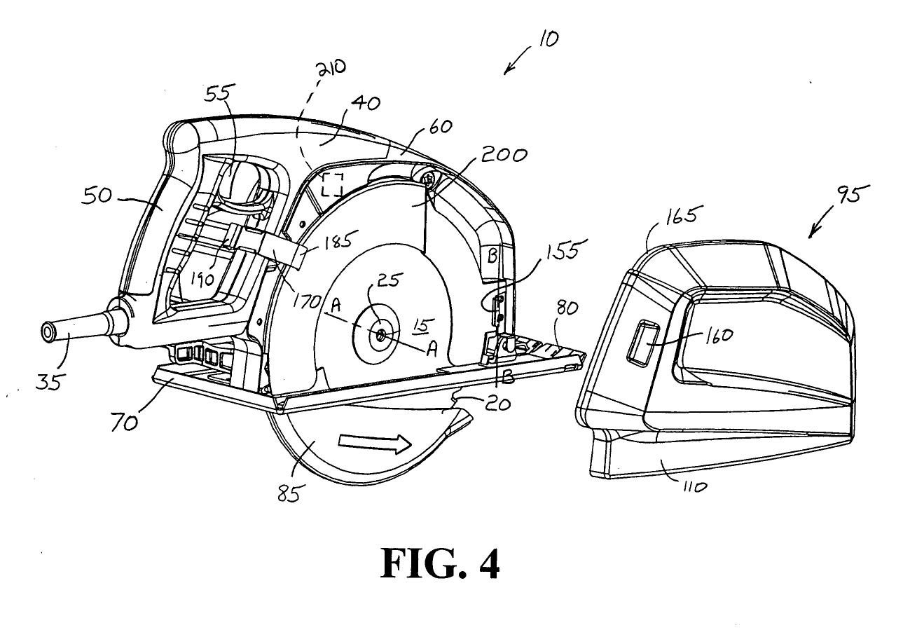

The saw 10 includes (see FIG. 4) a blade 15 supported for rotation (for example, in a counterclockwise direction in FIG. 4) about an axis A-A and in a plane substantially perpendicular to the axis A-A. The blade 15 includes a plurality of teeth 20 that are adapted to cut a work piece made of one or more types of material. For example, in the illustrated construction, the blade 15 has teeth 20 that are shaped to effectively cut metals. In other constructions (not shown), the blade may include teeth that are adapted to cut other material, such as, for example, wood, fiber board, etc.

Each tooth 20 includes a sharp leading edge that removes material as the blade 15 cuts the work piece. The tooth 20 removes material while traveling up through the work piece. In some aspects, the material then travels with the tooth 20 and the blade 15 until the material is removed or ejected, as described below in more detail.

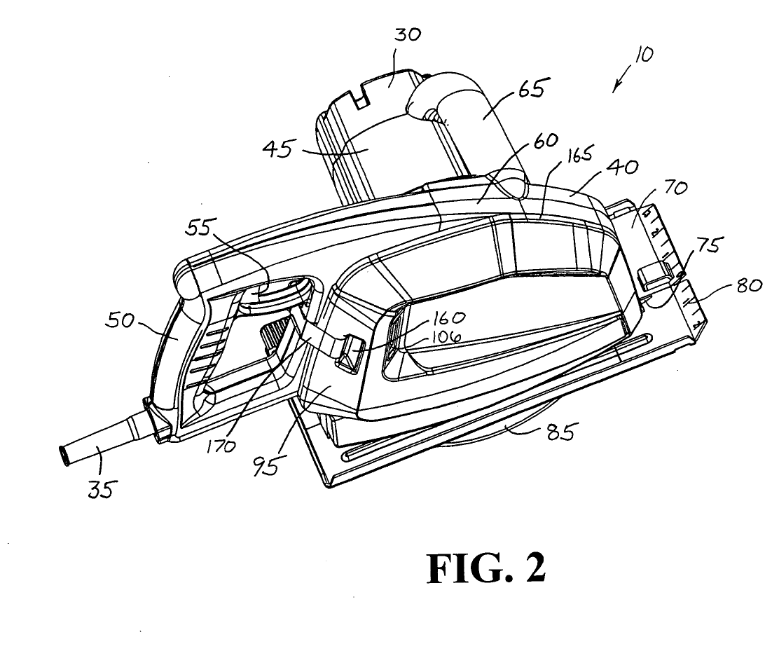

A spindle 25 supports the blade 15 on the blade rotational axis A-A. The spindle 25 includes a clamp end and a drive end. The clamp end clamps the blade 15 to the spindle 25 such that rotation of the spindle 25 produces a corresponding rotation of the blade 15. The drive end is rotatably connected to a motor 30 (schematically illustrated in FIG. 2) to produce the desired rotation of the spindle 25 and the blade 15.

The motor 30 generally includes a stator and a rotor supported to rotate at a desired speed in response to a flow of current. In the illustrated construction, the motor 30 drives the spindle 25 at the desired speed. In the illustrated construction, the motor 30 is an AC motor, and AC current is supplied to the motor through a power cord 35 (partially shown in FIGS. 1-5 and 7) from an AC power source. However, in other constructions (not shown), the motor may be a DC motor powered by a DC power source, such as a battery, to provide a cordless circular saw. In yet other constructions, the motor may be another type of motor powered by AC, DC or another power source.

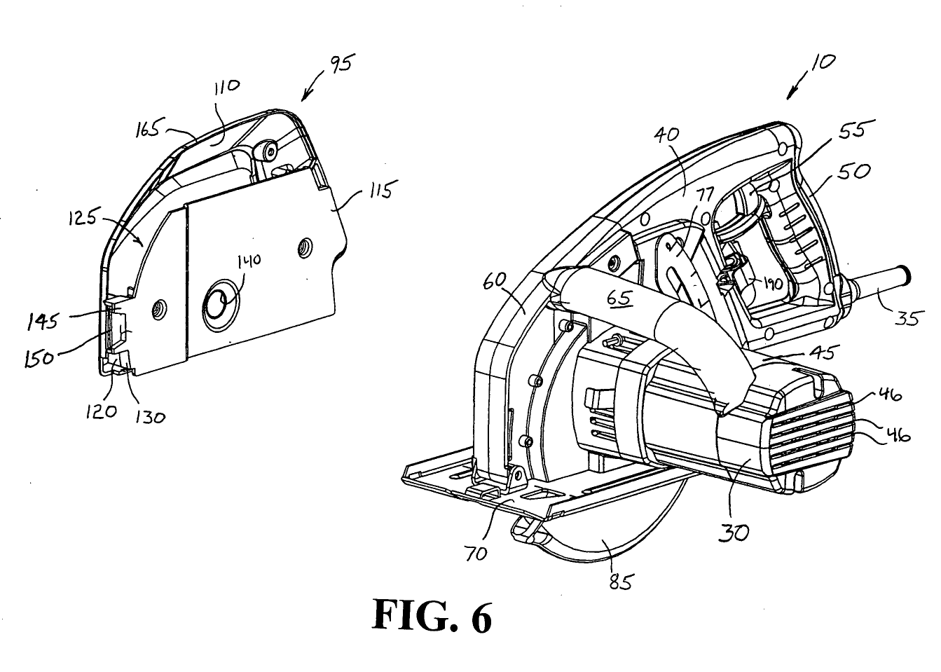

The power cord 35 extends out the rear portion of a housing 40. A portion of the cord 35 is disposed within the housing 40 and connects the motor 30 to the power source. The housing 40 also supports and covers the motor 30. Generally, the housing 40 is formed from a material, such as plastic or metal, in the shape of the circular saw 10. In the illustrated construction, a motor portion 45 of the housing 40 extends out at a right angle to the blade 15 to provide support and protection for the motor 30. A plurality of openings 46 in the housing 40 (see FIG. 6) facilitate air flow through the motor 30.

As shown in FIG. 2, the housing 40 includes a first handle member 50 that is aligned generally parallel to the plane of the blade 15. Typically, a user grasps the handle member 50 and pushes the saw 10 along the desired cut line. The first handle member 50 typically includes an on/off switch or trigger 55 that allows the user to selectively power the motor 30 to drive the blade 15.

The housing 40 also includes a blade-covering portion 60 which substantially covers one side of an upper portion of the blade 15 to prevent access to that side of the blade 15 and to contain chips, dust, or other debris. In addition, the housing 40 includes a second handle member 65 that extends generally at a right angle to the first handle member 50. The second handle member 65 connects at one end to the blade-covering portion 60 of the housing 40, and at the other end to the motor portion 45.

In operation, the user typically grasps the handle member 50 with one hand and the other handle member 65 with the other hand. The arrangement of the handle members 50, 65 allows for accurate and easy control of the circular saw 10 during sawing operations.

A shoe 70 is connected to the housing 40 and supports the circular saw 10 on the work piece. The shoe 70 is generally oriented perpendicular to the plane of the blade 15 and separates the upper portion of the blade 15 from a lower portion. The shoe 70 includes a slot 75 through which the blade 15 passes. The bottom surface of the shoe 70 is engageable with a surface of the work piece and is smooth to allow the shoe 70 to slide across the surface of the work piece as the blade 15 cuts the work piece.

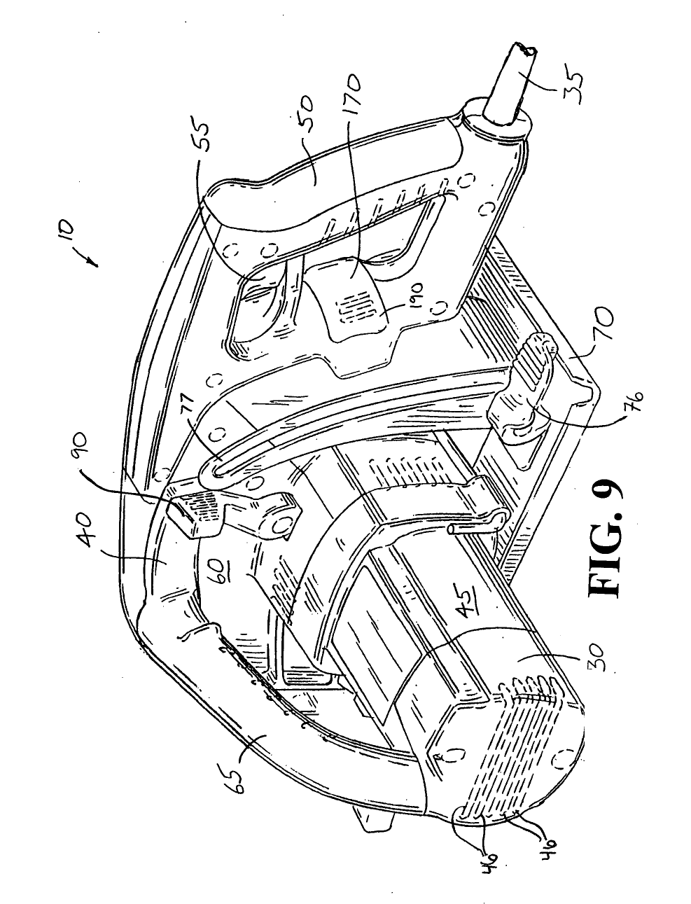

Generally, the shoe 70 is pivotable with respect to the housing 40 in order to adjust the cutting depth of the saw blade 15 and may be pivotable to adjust the cutting angle of the saw blade 15. Referring to FIG. 9, the circular saw 10 includes an adjustment lever 76 connected to the housing 40 and pivotable relative to the housing 40. The adjustment lever 76 is adjustable to selectively engage a depth determining flange 77, which is connected to the shoe 70 and includes a plurality of depth calibrations (not shown) thereon that correspond to the cutting depth of the blade 15. In the illustrated construction, the lever 76 is rotated in a first direction to loosen the engagement between the lever 76 and the flange 77. After loosening the engagement between the lever 76 and the flange 77, the housing 40 and the lever 76 are movable relative to the shoe 70 and the flange 77 to adjust the cutting depth of the blade 15. Once the cutting depth and/or the cutting angle is appropriately set, the lever 76 is rotated in a second direction, opposite the first direction, to tighten the engagement between the lever 76 and the flange 77 to lock the lever 76 and housing 40 to the flange 77.

It should be understood that the cutting angle of the saw blade and the cutting depth can be adjusted or controlled in a manner different than that illustrated. For example, a spring-biased press button (not shown) can be used rather than the lever 76. Such a press button would have a first condition, in which the saw and the cutting depth were locked and not adjustable, and a second condition, in which the saw would be pivotally adjustable and the cutting depth adjustable.

In some constructions, the shoe 70 includes markings 80 that indicate the position of the saw blade 15 relative to the work piece. These markings 80 may be provided by a line, indentation, or opening or may include multiple lines and numbers that allow the shoe 70 to be used as a measuring device.

Returning to FIG. 1, a pivotable lower guard 85 is pivotally attached to the saw 10 to selectively cover the bottom portion of the blade 15 below the shoe 70 so that, at most, only a small portion of the front of the blade 15 is exposed. During cutting, the lower guard 85 engages the work piece and thereby pivots (in a clockwise direction in FIG. 1) to expose more of the blade 15 to cut the work piece.

A lever 90 (see FIG. 9) facilitates manual repositioning (i.e., opening) of the lower guard 85. In the illustrated construction, the lever 90 is positioned on the handle side of the housing 40, rather than on the opposite blade side of the housing 40, to make it easier for a user to actuate the lever 90. The user can actuate the lever 90 to move the lower guard 85 out of the way to uncover the lower portion of the blade 15 (i.e., at the start of a cut, to replace the blade 15, etc.) without releasing either handle member 50, 65.

As shown in FIGS. 1-7 and 10-13, in some aspects, the circular saw 10 includes a removable cover 95 attached to the housing 40 to cover the other side of the upper portion of the blade 15. The cover 95 may be formed from a material, such as, for example, plastic, metal, or another suitable material. In some constructions, the removable cover 95 is formed as a single piece, while other constructions use a multi-piece construction.

In some aspects, the removable cover 95 also acts as a collection portion, cavity or receptacle for the chips and dust produced by the blade 15 during cutting. Therefore, the removable cover 95 is positioned to not only cover the blade 15 but to capture a majority of the chips produced during cutting and to contain the chips before the chips escape from the circular saw 10 into the work area.

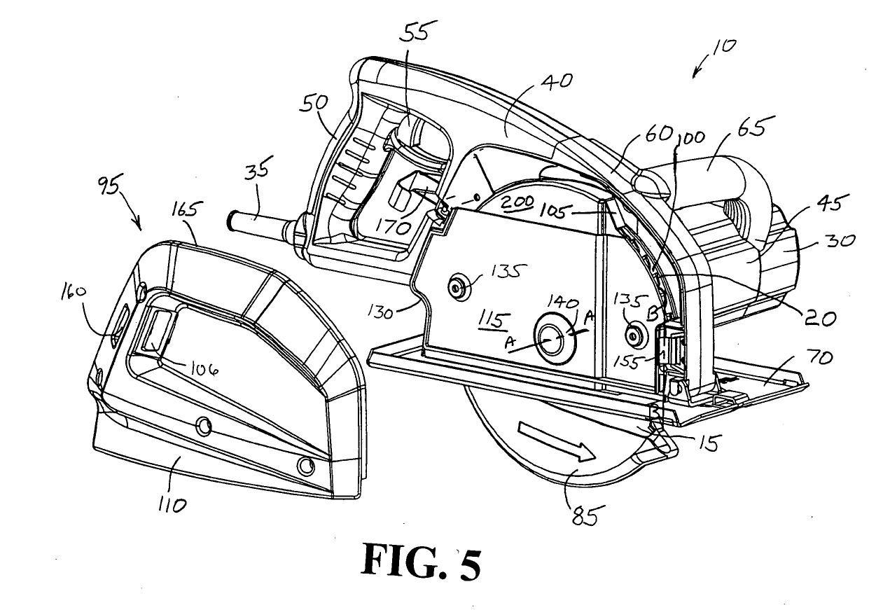

As shown in FIG. 5, a slot 100 (described below) partially exposes a portion of the upper portion of the blade 15. As the blade 15 rotates, chips or debris caught in the teeth 20 are accelerated both circumferentially and radially away from the rotational axis A-A of the blade 15. The chips remain substantially between the teeth 20 until the teeth 20 pass into the partially exposed slot 100. Once in the exposed slot 100, the chips move radially away from the teeth 20.

A tab member 105 (illustrated best in FIG. 5) disposed at the end of the exposed slot 100 deflects the chips and other debris away from the blade 15 so that the chips are directed to and settle in the removable cover 95. The removable cover 95 may also include a transparent viewing port or window 106 through which an operator can see to identify the level of chips and debris in the removable cover 95. In the illustrated construction, the window 106 is made of at least somewhat transparent material, such as, for example, plastic, Plexiglas, glass, etc. When the removable cover 95 is full, the user removes the removable cover 95 and empties the chips into a trash receptacle or recycle bin for proper disposal. Thus, the removable cover 95 collects the debris created by the circular saw 10 before the chips are dispersed into the work area.

As illustrated in FIG. 6, the cover 95 includes an outer wall 110 and an inner wall 115 connected to the outer wall 110. A lateral surface 120 extends between the inner wall 115 and outer wall 110 to define a chamber 125. The inner wall 115, attached to the circular saw 10 and disconnected from the outer wall 110 in FIG. 5, includes raised peripheral edges 130 that partially surround the exterior of the wall 115. Two spacers 135 project into the chamber 125 and maintain the desired distance between the inner wall 115 and the outer wall 110. The inner wall 115 also defines a large circular cavity 140 positioned to receive the clamp end of the spindle 25 therein and facilitate rotation of the spindle 5 without interference with the inner wall 115.

As shown in FIG. 6, the inner wall 115 is shown attached to the outer wall 110 thus concealing the outer surface of the inner wall 115. The peripheral edges 130 abut the inner surface of the outer wall 110 to define the lateral surface 120 of the cover 95. In other constructions (not shown), the outer wall 110 includes interior edges that align with the peripheral edges 130 of the inner wall 115 to define the lateral surface 120 of the cover 95. In still other constructions (not shown), a separate piece engages the inner wall 115 and/or the outer wall 110 to define the lateral surface 120.

Referring now to FIGS. 5-6 and 8, the front portion of the inner wall 115 includes a fork member 145 that supports a ledge 150. The ledge 150 is sized to pivotally engage a hook member 155 supported by the housing 40. The hook member 155 defines a pivot axis B-B for the removable cover 95. In addition, the hook 155 and ledge 150 arrangement allows for quick and easy removal of the cover 95 from the circular saw 10 when desired. It should be understood that, in other constructions (not shown), a pin or similar structure (not shown) may replace the ledge 150.

The outer wall 110 is formed to be both visually appealing and to, in some aspects and in some constructions, contain chips and dust within the removable cover 95. The outer wall 110 contour substantially matches the contours of the blade-covering portion 60 of the housing 40. In addition, a locking recess or latch pocket 160 is formed into the outer wall 110 to facilitate attachment of the cover 95 to the housing 40 (discussed in greater detail below) for sawing operations. The outer wall 110 may include interior edges and spacers as described with respect to the inner wall 115.

The outer wall 110 includes a periphery 165 that engages the housing 40 and substantially seals the interior of the removable cover 95 to prevent escape of the chips. With the removable cover 95 assembled and installed, a majority of the chips enter the chamber 125 defined by the removable cover 95.

In the illustrated construction, the inner wall 115 is fixed to the outer wall 110, i.e., by screws. Standoffs or spacers positioned between the inner wall 115 and outer wall 110 assure the proper chamber size. The top of the chamber 125 remains open to allow chips and dust to collect therein. In another construction (not shown), the lateral surface 120 acts as a spacer and no standoffs are required. In yet another construction (not shown), the removable cover 95 is formed as a single piece rather than an assembly of the above-described components.

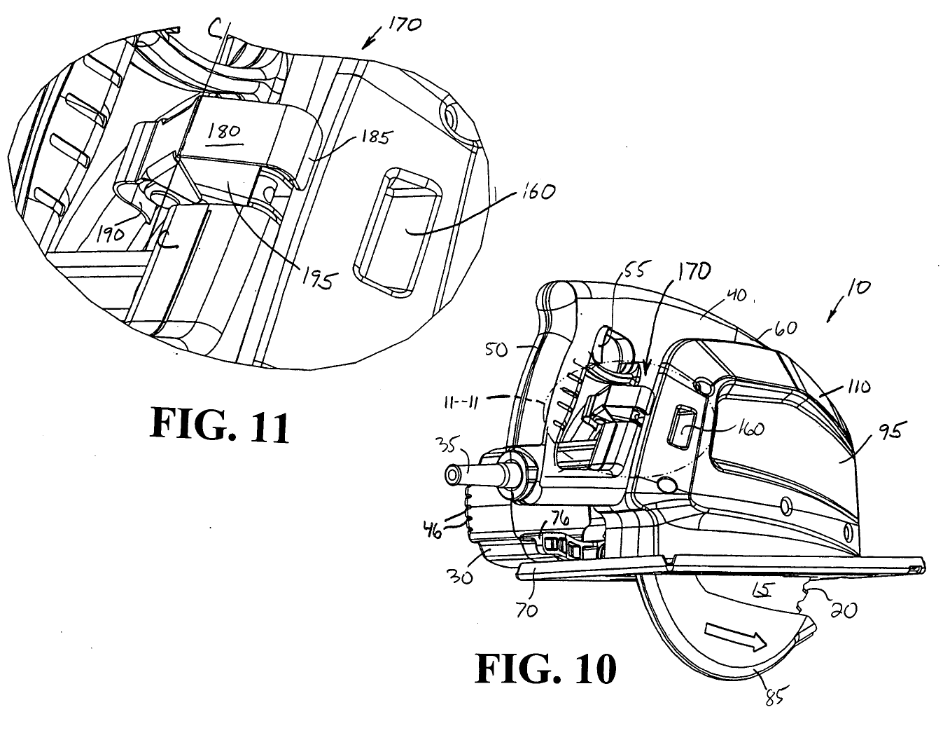

Referring to FIGS. 10-13, in the illustrated construction and in some aspects, a quick-locking member or latch 170, supported by the first handle portion 50, and the hook 155, at the opposite end of the housing 40, facilitate attachment and removal of the removable cover 95 to and from the housing 40. The cover ledge 150 near the front of the removable cover 95 engages the hook member 155 such that the removable cover 95 is pivotable about the axis B-B of the ledge 150 between an attached position, in which the latch 170 is engageable in the latch pocket 160 and the cover 95 engages the housing 40, and a detached position, in which the latch 170 is disengaged from the latch pocket 160 and the removable cover 95 is pivoted away from the housing 40. When the latch 170 is engaged with the latch pocket 160, the cover 95 is firmly held in place against the housing 40.

As illustrated, the latch 170 is similar to a ski-boot type latch and is used to facilitate easy installation and removal (i.e., quick-release) of the removable cover 95 without the use of tools (i.e., tool-less). The ski-boot type latch 170 can be made adjustable to allow the user to adjust the amount of force applied to the removable cover 95 when it is installed.

With particular reference to FIGS. 10-11, the latch 170 is shown in an open and disengaged position. The latch 170 includes a hook member 180 having a hook end 185 and an actuating end 190. The hook end 185 is shaped to engage the latch pocket 160 of the removable cover 95 and to force the cover 95 against the housing 40 when the latch 170 is closed. The actuating end 190 is positioned on the opposite end of the hook member 180 to allow the user to easily actuate the latch 170.

The hook member 180 connects to a spacer member 195 in a manner that allows the hook member 180 to pivot about a first pivot axis C-C. The opposite end of the spacer member 195 pivotally connects to the housing 40. With this arrangement, the hook member 180 is pivotable about both ends of the spacer member 195.

In another construction (not shown), the spacer member may have an adjustable length (and an adjustable latching force). In such a construction, the adjustable length allows for a variation in the distance between the two pivot axes, which results in variation in the force applied to the cover 95 by the hook member 180 when in the attached position.

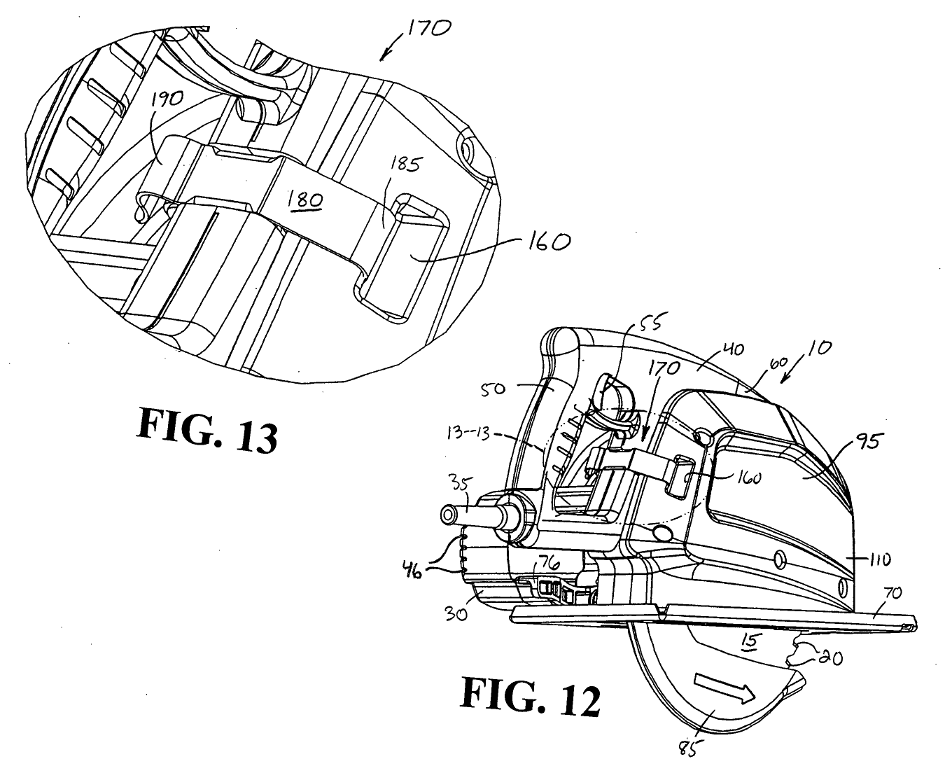

With particular reference to FIGS. 12 and 13, the latch 170 is illustrated in the closed and engaged position such that the latch 170 retains the removable cover 95 against the housing 40. To close the latch 170, the actuating end 190 of the hook member 180 is lifted to move the hook end 185 into engagement with the latch pocket 160. Once the hook end 185 engages the latch pocket 160, the actuating end 190 is pushed toward the housing 40. The force applied to the hook end 185 increases until the maximum force point is reached. The maximum force point is the point at which the first pivot axis C-C is at its greatest distance from the latch pocket 160. At this position, the latch 170 is not fully closed and is thus depressed still further. As the latch 170 is depressed, the first axis C-C moves closer to the latch pocket 160, thereby reducing the force applied by the hook end 185. Once closed, an increase in force must be applied to open the latch 170. Thus, the latch 170 is mechanically biased in the latched position.

In some constructions (not shown), a biasing member biases or retains the latch 170 and/or the hook member 180 further toward or into the latched position to further enhance its ability to retain the removable cover 95 in position. Biasing members such as compression springs, tension springs, or torsional springs could be employed to bias the latch 170.

It should be understood that “quick-locking” may mean that the operator performs a relatively-simple locking/unlocking movement, such as, for example, actuating the latch 170. Other “quick-locking” type movements may include a simple pivoting movement of, for example, less than 360°, such as is typically required for a threaded fastener. Additionally, this may include movement in which an operator does not have to re-position a hand, a removal tool or the saw 10 during locking and unlocking, such as is typically required with the threaded fastener.

It should also be understood that “tool-less” and “without the use of tools” may mean that the operator may perform the locking/unlocking movement without an additional removal tool, such as, for example, a screwdriver, wrench, key, etc. The operator may perform the locking/unlocking movement with a hand, finger, etc. However, while an additional removal tool may not be required, the operator may choose to use such an additional removal tool, if one is available.

Other locking mechanisms (not shown) may also be used with aspects of the present invention. For example, a cover including a belt having a plurality of steps could be employed. The belt would fit into a ratchet mechanism attached to the housing such that the ratchet mechanism retains the cover in the desired position. In yet another construction (not shown), a rubber or rubber-like belt includes apertures sized to receive pins. One end of the belt attaches to the cover while the second end attaches to the housing to retain the cover.

As is evident from the above-described examples, there are many ways of including a quick-release, tool-less locking assembly to retain the removable cover 95 in the desired position. Therefore, the invention should not be limited to only those examples listed herein.

Referring back to FIG. 4, the circular saw 10 is shown with the removable cover 95 removed and, in some aspects and in some constructions, an inner cover 200 covers the teeth 20 of the blade 15 in the area covered by the removable cover 95 when the removable cover 95 is attached to the housing 40.

In some aspects and in some constructions, the inner cover 200 (see FIGS. 4 and 78) is fixed to the housing 40 and covers the portion of the rim of the blade 15 disposed under the removable cover 95. The blade 15 rotates in an opening between the housing 40 and the inner cover 200. The inner cover 200 and the blade-covering portion 60 of the housing 40 cooperate to cover the teeth 20 on the upper portion of the saw blade 15 so that teeth 20 cannot be contacted by an object when the removable cover 95 is removed. The inner cover 200 may extend radially beyond the teeth 20 of the blade 15.

During a cutting operation, the teeth 20 carry chips and dust up and into the space between the inner cover 200 and the housing 40. The inner cover 200 cooperates with the housing 40 to define the open slot 100 around a portion of the circumference of the blade 15. The open slot 100 allows the chips and other debris to exit the blade teeth 20 and the space between the inner cover 200 and housing 40. Thus, the chips are flung out of the saw blade 15 area, into the housing 40, and eventually into the chamber 125 of the removable cover 95.

The inner cover 200 is formed to allow the lower blade guard 85 to rotate within the space between the inner cover 200 and the housing 40. During a cut, the user pushes the circular saw 10 forward against the work piece which acts to rotate the lower blade guard 85 into the space between the inner cover 200 and the housing 40. The lower blade guard 85 also rotates to facilitate blade removal. When removing or replacing a blade 15, the inner cover 200 prevents blade removal above the shoe 70. Instead, the user rotates the lower guard 85 to allow the blade 15 to drop vertically through the shoe 70.

It should be understood that the inner cover 200 may be incorporated into existing circular saws with removable covers/chip collectors (such covers/collectors are not quick-connect and/or require tools to be connected and removed from the saw (i.e., the cover/collector is removably connected to the saw by screws)).

In some aspects and in some constructions, an interlock assembly 210 (schematically illustrated in FIGS. 4 and 7-8) may be provided to interact with the removable cover 95 and/or with the cover locking assembly. The interlock assembly 210 may be configured to prevent rotation of the motor 30, limit operation of the circular saw 10, and/or provide an indication when the removable cover 95 is removed from the circular saw 10 and/or not completely connected to the housing 40 and/or when the cover locking assembly is not in the locked condition.

The interlock assembly 210 may include a sensor, such as, for example, an optical, electrical (i.e., circuit completed by the presence of the removable cover 95), magnetic (i.e., Hall Effect sensor), or mechanical devices (i.e., depressible plunger), for sensing the presence of the removable cover 95. Such a sensor may be operably coupled to the circular saw 10 to affect operation of the circular saw 10 based on the sensed condition of the removable cover 95. If the sensor detects that the removable cover 95 is removed and/or is not completely connected to the housing 40 and/or that the cover locking assembly is not in the locked condition, a signal is produced that affects the operation of the circular saw 10 (i.e., prevents the motor 30 from operating, limits operation of the circular saw 10 and/or provides an indication of a missing or improperly connected removable cover 95).

The interlock assembly 210 may include structure interacting with the cover locking assembly (i.e., the latch 170 and the latch pocket 160 and/or ledge 150 and the hook member 155. Such structure may include a sensor (not shown) producing a signal, as described above, or may physically affect operation of the circular saw 10.

As is evident from the above-described examples, there are many ways of including an interlock assembly 210 in the above-described invention. Therefore, the invention should not be limited to only those examples described herein. Further, the interlock assembly 210 may be incorporated into the existing circular saws with the non quick-connect, non tool-less removable covers, described above.

Several limitations exist with interlock assemblies. For example, the interlock assembly 210 may be unreliable and malfunction (i.e., due to contamination or debris (even from operation of the circular saw 10)), thereby permanently disabling the motor 30 and the circular saw 10. Due to the complexity of an interlock design, potential maintenance requirements for the user are increased. Also, the interlock assembly 210 may be bypassed by a user, rendering the interlock assembly 210 useless. Such limitations may explain why interlock assemblies are not used with the existing saws with the non quick-connect, non tool-less removable covers, described above, and, because of these limitations, the fixed inner guard 200 is preferred in related aspects of the invention.

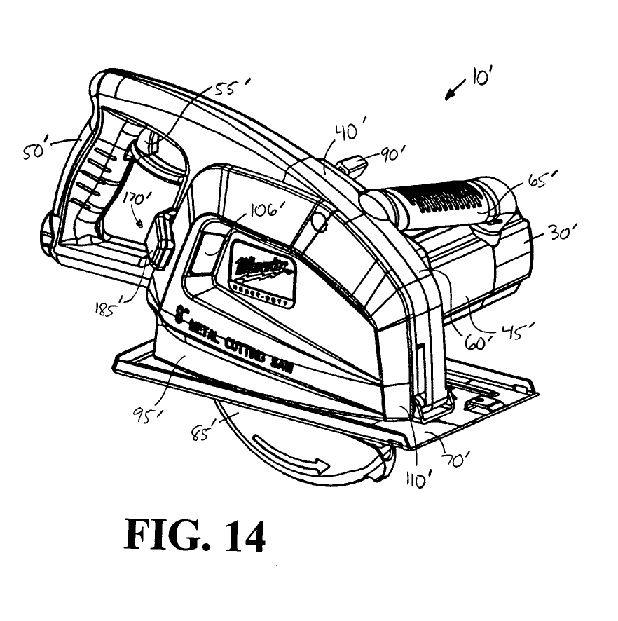

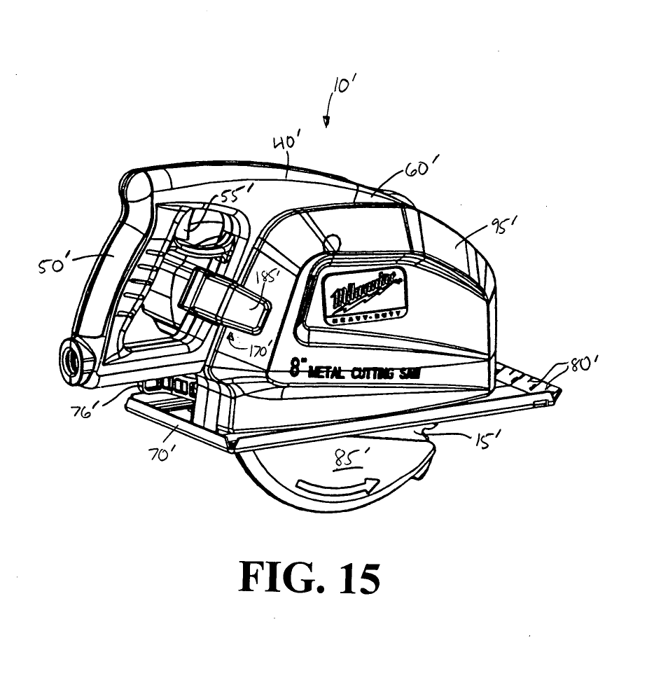

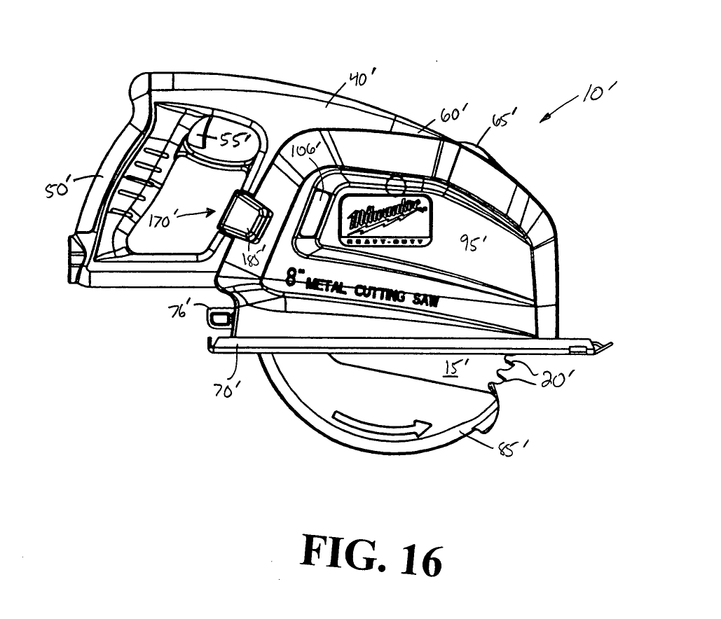

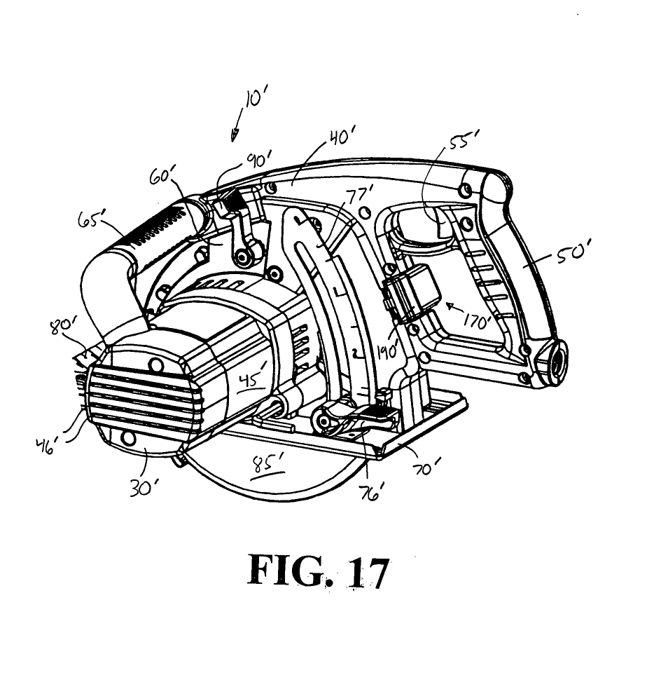

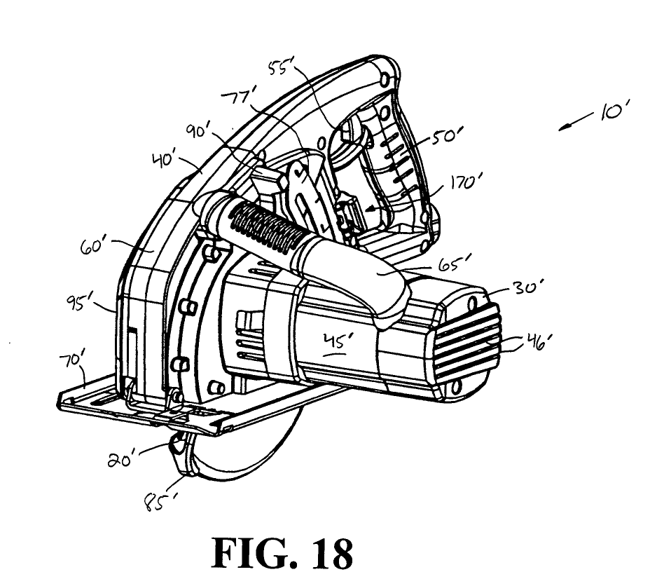

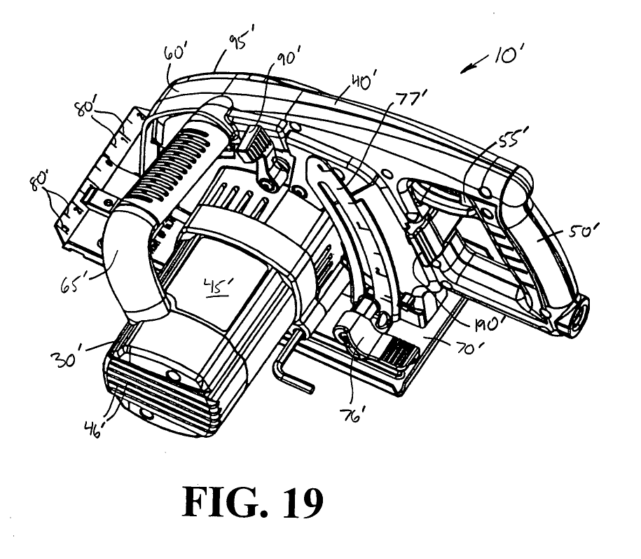

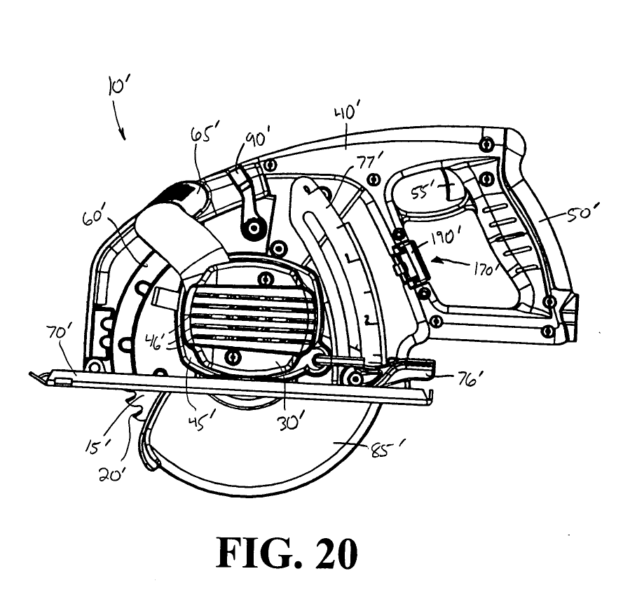

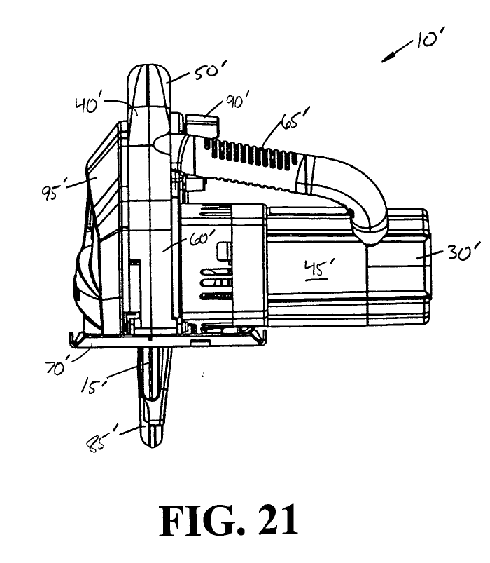

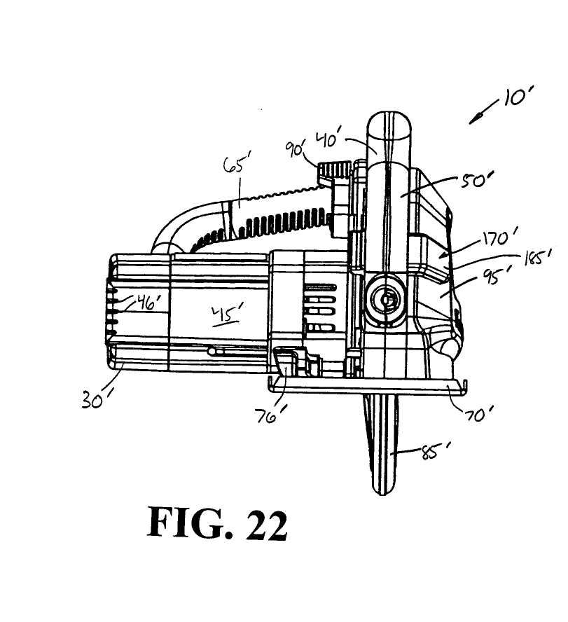

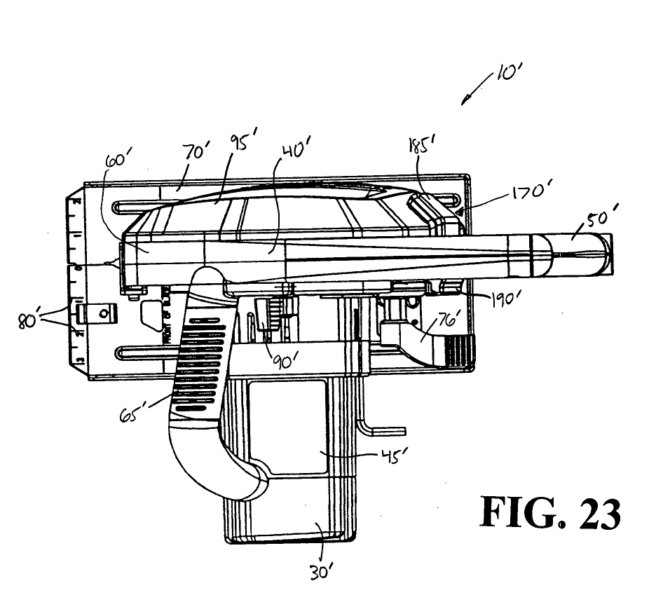

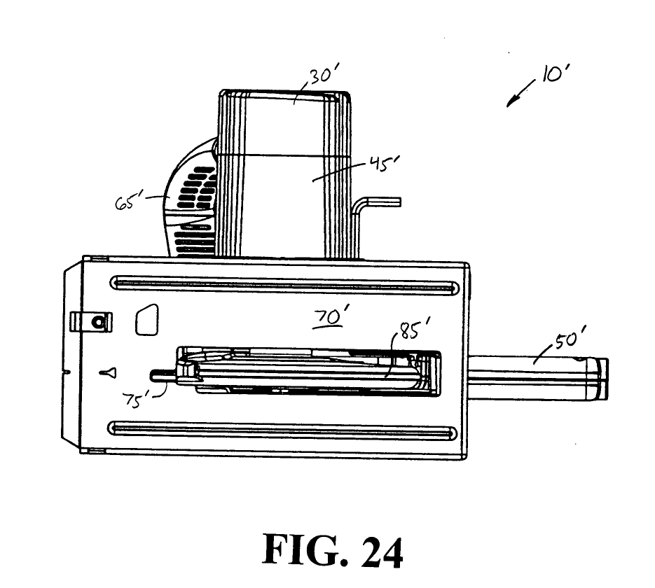

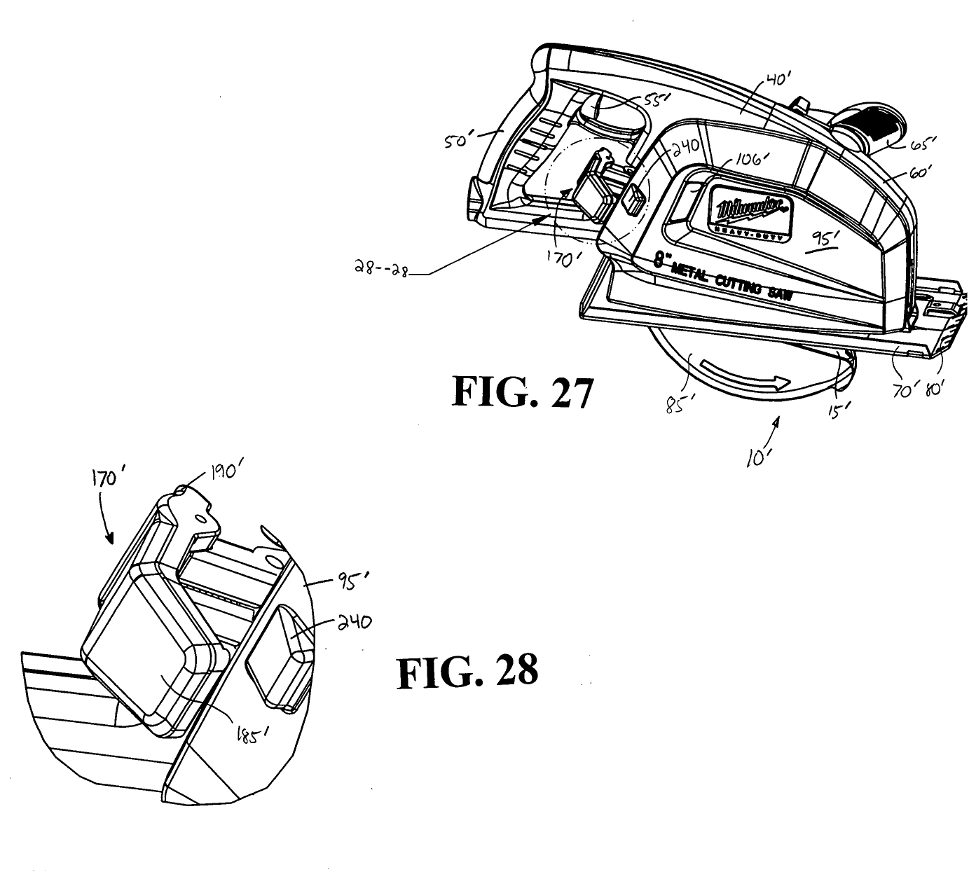

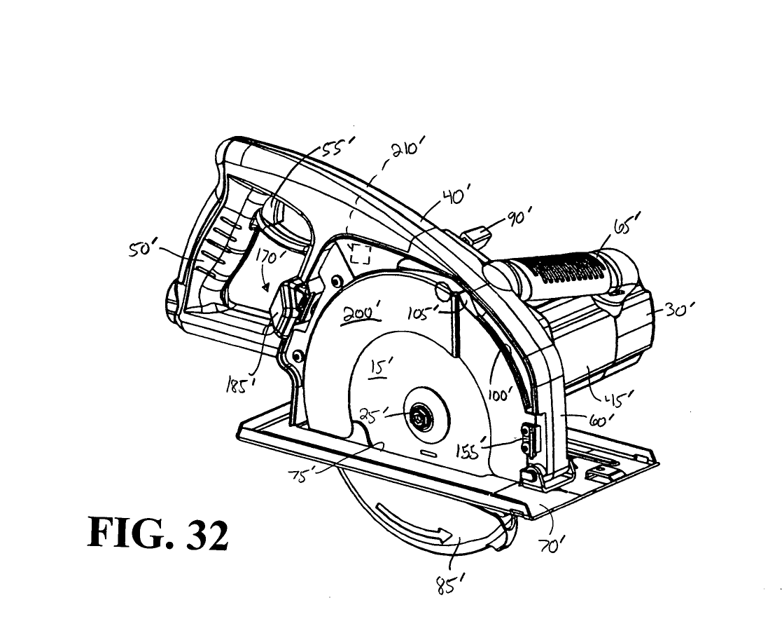

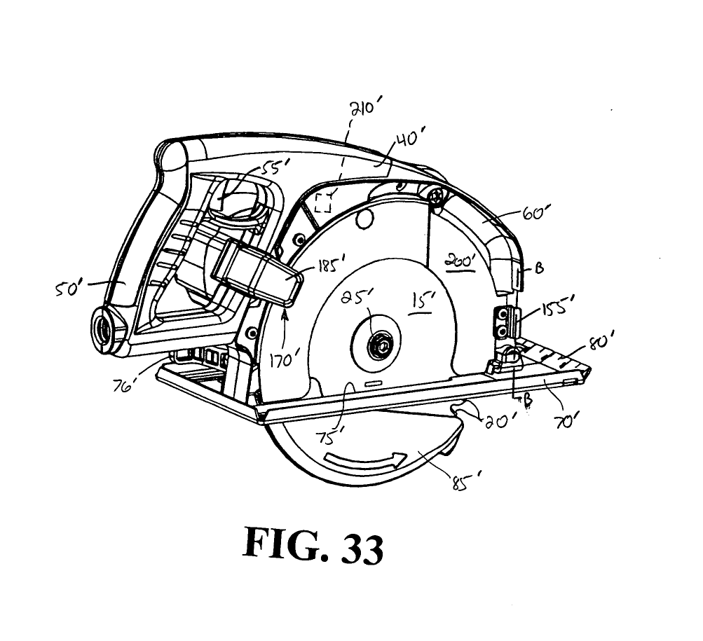

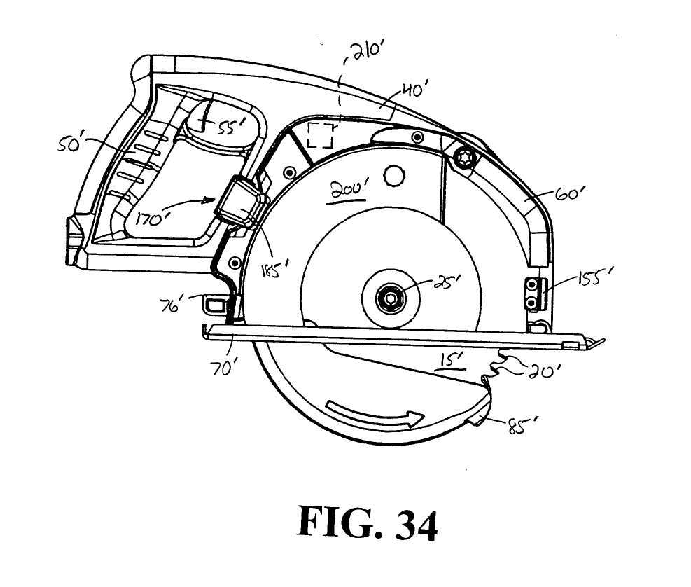

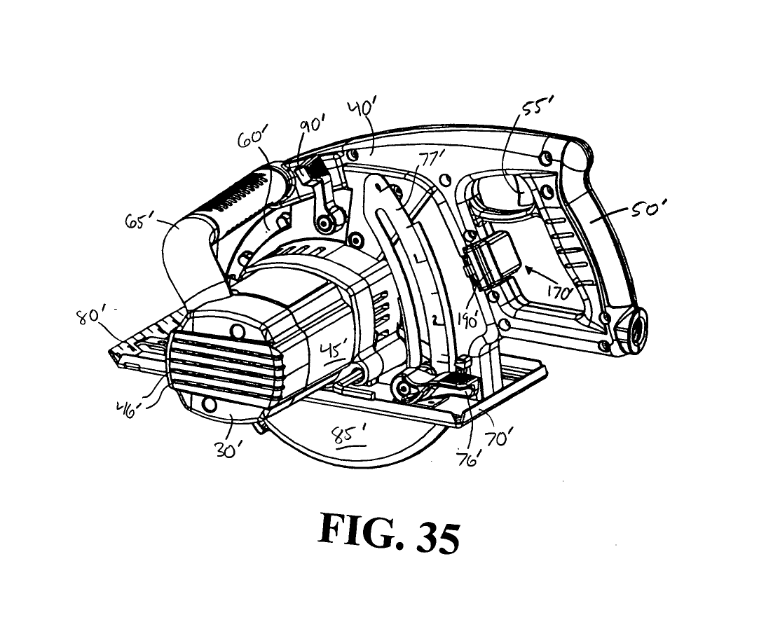

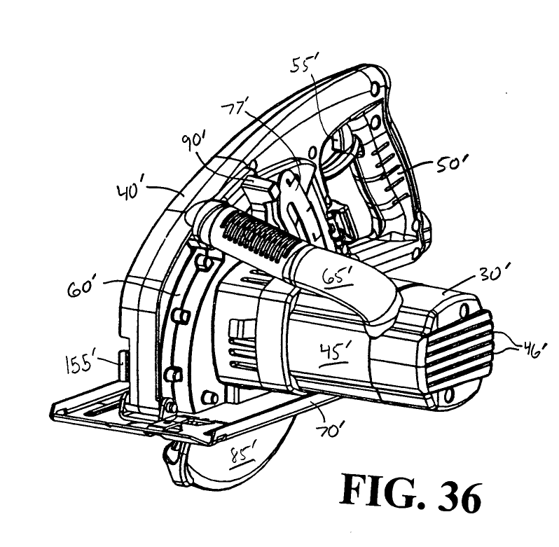

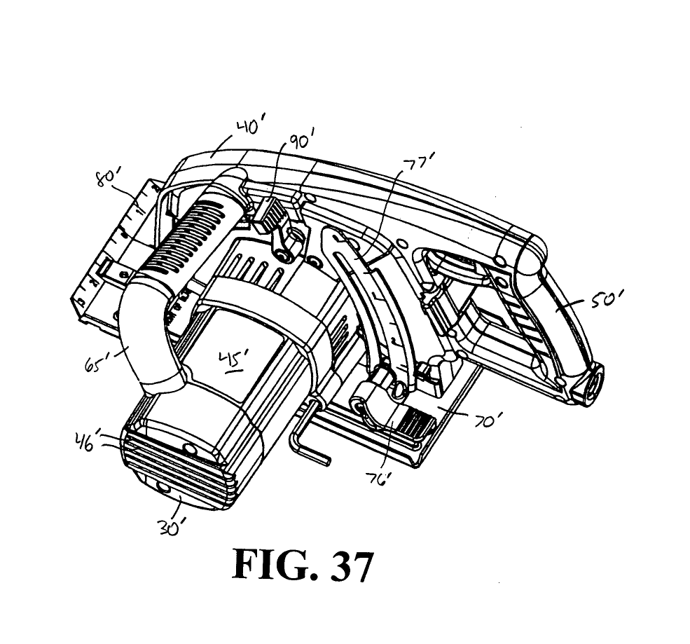

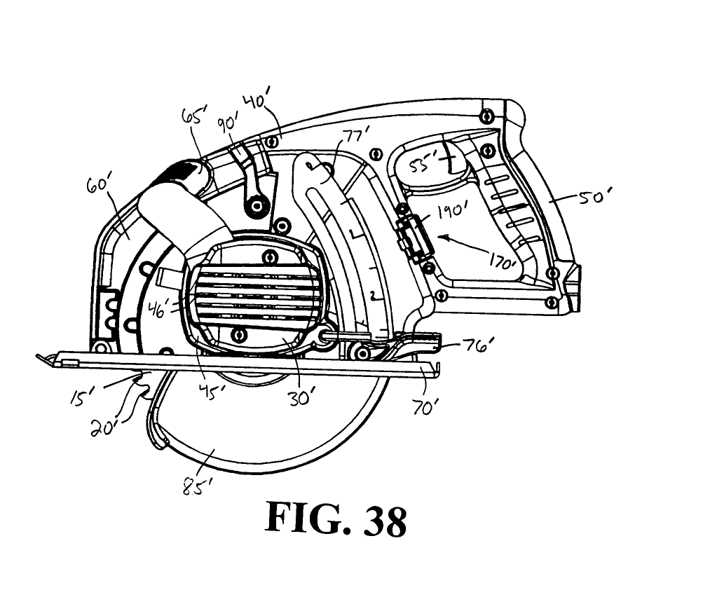

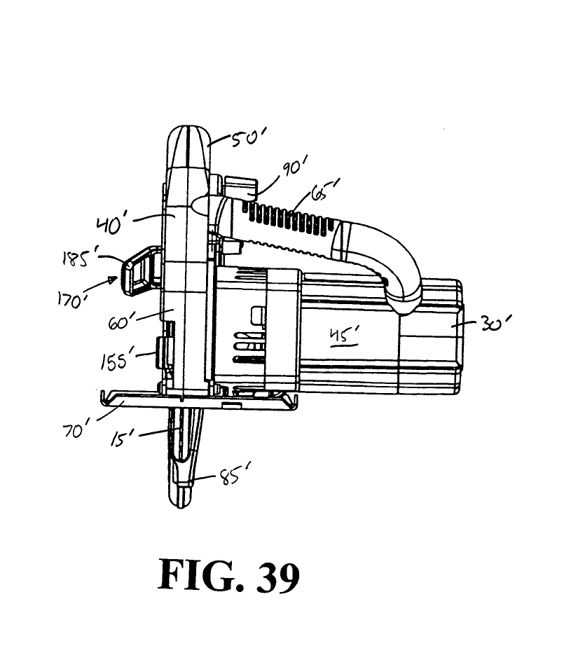

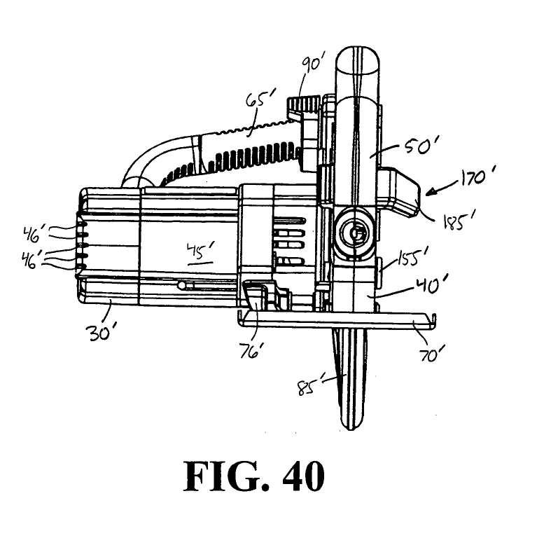

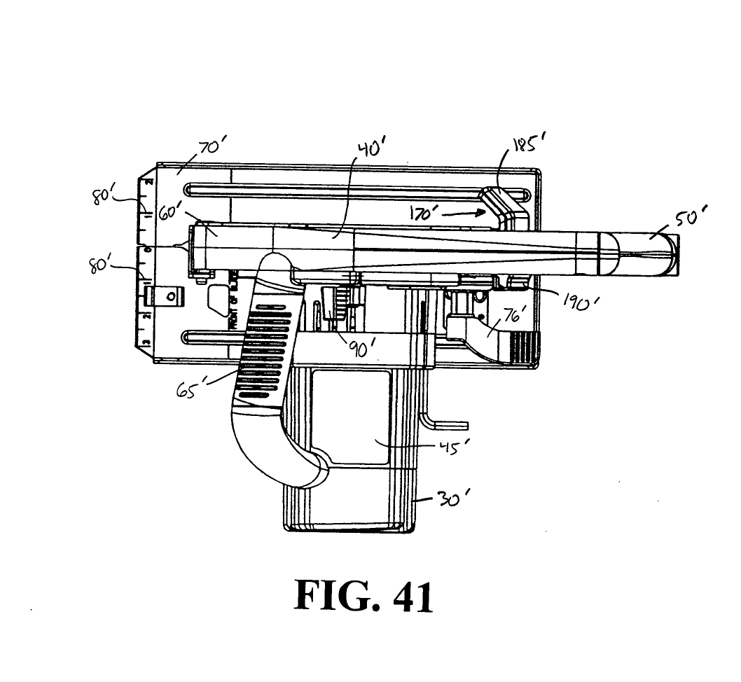

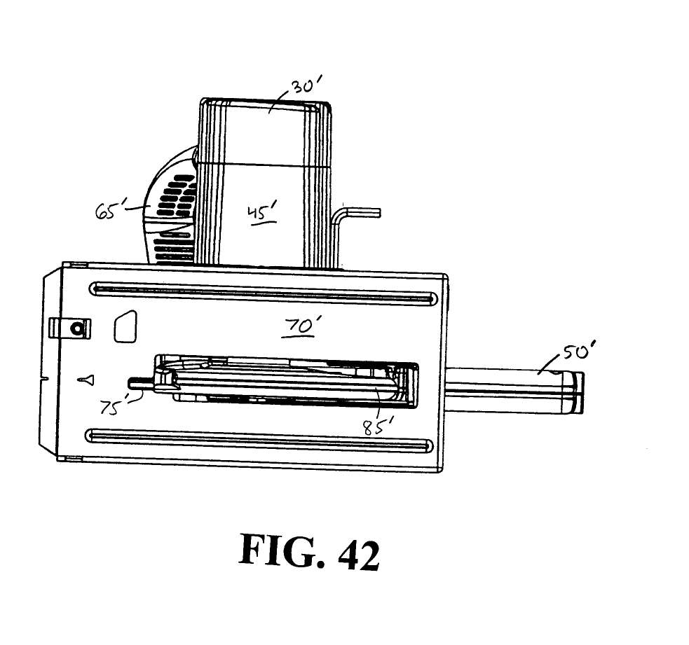

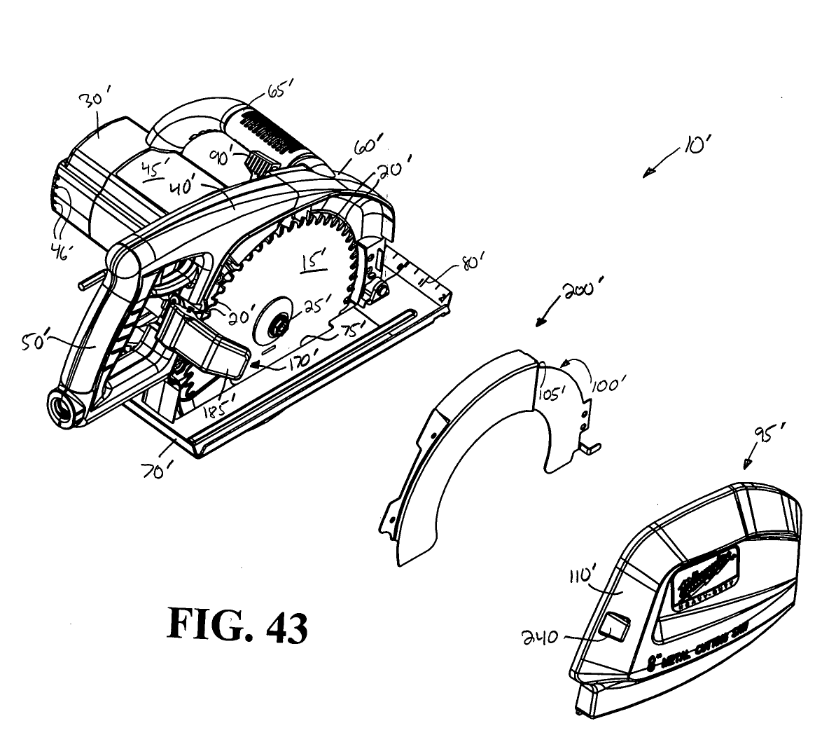

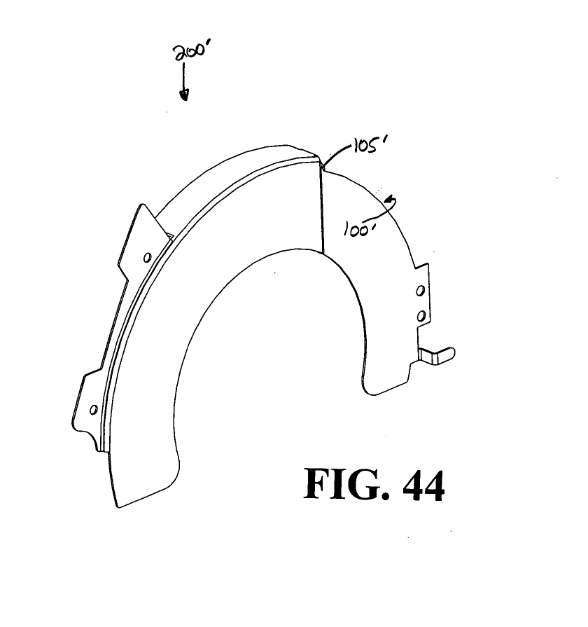

Referring to FIGS. 14-44, a second construction of the circular saw 10 is illustrated. With some exceptions (described in greater detail below), the circular saw 10′ illustrated in FIGS. 14-44 is similar to the circular saw 10 described above with reference to FIGS. 1-13. Accordingly, reference is made to the above discussion regarding the structure, operation, and alternatives of the circular saw 10′ illustrated in FIGS. 14-44. Common elements are identified by the same references numbers “′”.

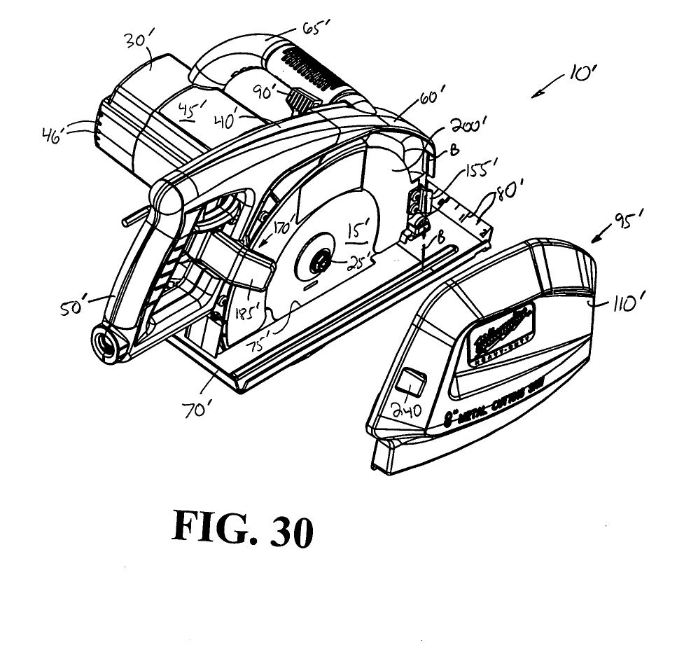

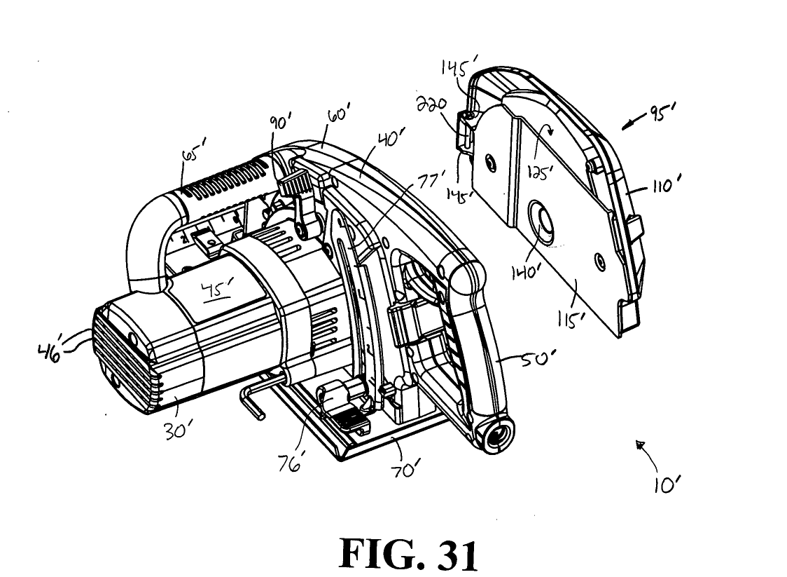

With particular reference to FIGS. 30 and 31, the circular saw 10′ includes a removable cover 95′ that is selectively connectable to the housing 40′ of the circular saw 10′. The removable cover 95′ includes a fork member 145′ and a rotatable pin 220 (see FIG. 31) supported in a substantially vertical orientation by the fork member 145′ and rotatable relative to the fork member 145′. A hook member 155′ is connected to the housing 40′ of the circular saw 10′. In the illustrated construction, the hook member 155′ is connected to the housing 40′ with fasteners. However, in other constructions, the hook member 155′ can be connected to the housing 40′ in other manners, such as, for example welding, brazing, or other types of bonding, or can be integrally formed with the housing 40′.

The hook member 155′ and the pin 220 are engageable with each other to assist in connecting the cover 95′ to the housing 40′. The hook member 155′ defines a pivot axis B-B about which the pin 220 is pivotal when the cover 95′ is moved between the attached position and the detached position.

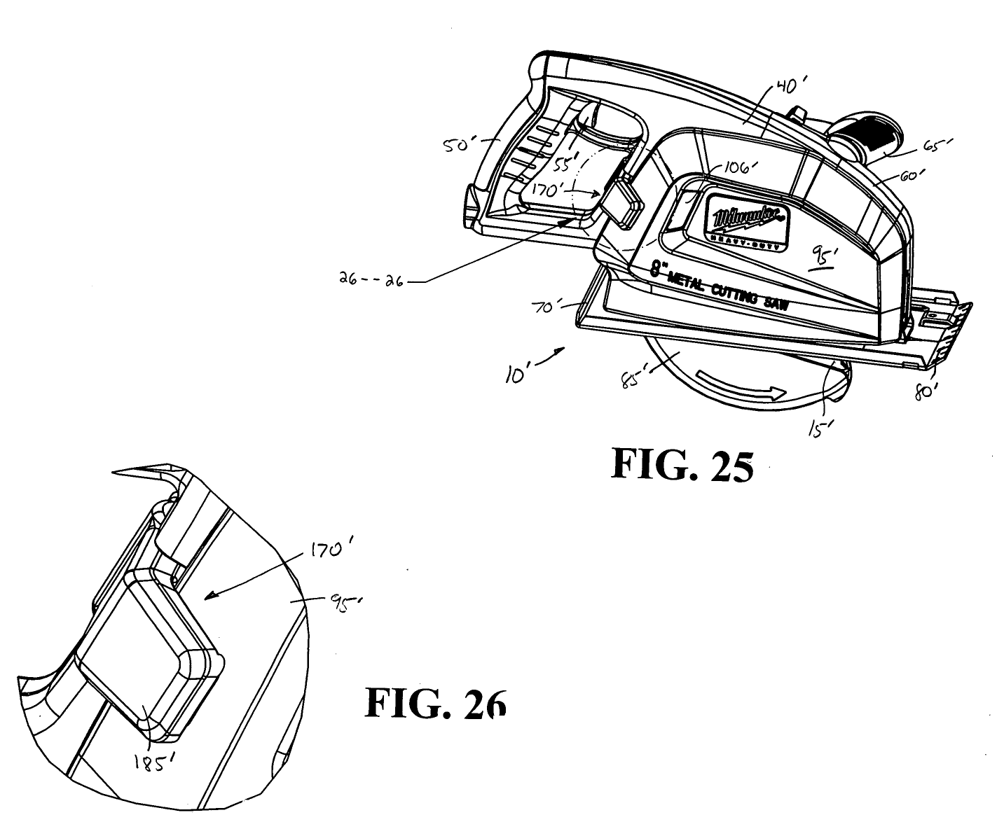

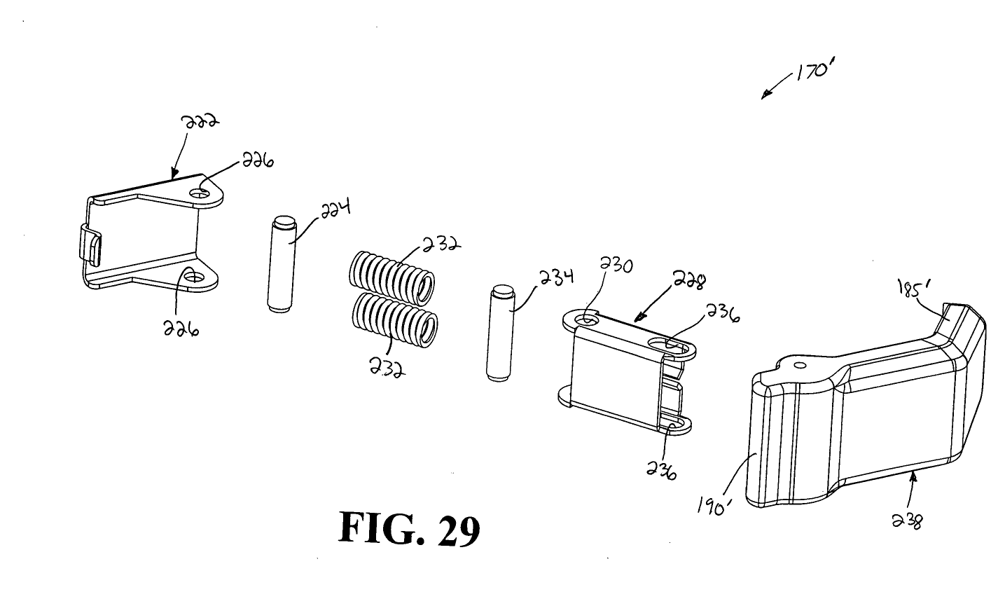

Referring now to FIGS. 25-31, the latch 170′ is supported by the housing 40′ and is engageable with the cover 95′ to selectively connect the cover 95′ to the housing 40′. In some constructions (not shown), the latch 170′ is supported by the cover 95′ and engageable with the housing 40′ to selectively connect the cover 95′ to the housing 40′. With particular reference to FIG. 29, the latch includes a connecting bracket 222 connected to the housing 40′. In the illustrated construction, the bracket 222 is connected to the housing 40′ with fasteners. However, the bracket 222 can be connected to the housing 40′ in other manners, such as, for example welding, brazing, or other bonding process, or can be integrally formed with the housing 40′. A first pivot pin 224 is connected to the bracket 222 and is received within bracket apertures 226 defined in the bracket 222. In some constructions, the first pivot pin 224 is press fit within the apertures 226 in order to prevent pivoting of the pin 224 relative to the bracket 222. In other constructions, the first pivot pin 224 is pivotal within the bracket apertures 226 relative to the bracket 222.

An intermediate latch member 228 is pivotally connected to the first pivot pin 224 and includes a first set of apertures 230 within which the first pivot pin 224 is received. The intermediate latch member 228 is pivotal relative to the first pivot pin 224. A pair of biasing members 232 are disposed within the intermediate latch member 228 and assist in latching the cover 95′ to the housing 40′ (discussed in greater detail below). In the illustrated construction, the biasing members 232 are coil springs. In other constructions, any type of biasing members and any number of biasing members 232, including none, can be used to appropriately bias the latch 170′ (discussed in greater detail below). The latch 170′ also includes a second pivot pin 234 connected to the intermediate latch member 228 and received within a second set of apertures 236. In some constructions, the second pivot pin 234 is press-fit within the second set of apertures 236 in order to prevent pivoting of the second pivot pin 234 relative to the intermediate latch member 228. In other constructions, the second pivot pin 234 is pivotal within the second set of apertures 236 relative to the intermediate latch member 228. In the illustrated construction, the second set of apertures 236 are elongated to allow the second pivot pin 234 to translate therewithin (discussed in greater detail below). When assembled, first ends of the biasing members 232 engage a flange (not shown) of the intermediate latch member 228 and second ends of the biasing members 232 engage the second pivot pin 234.

The latch 170′ also includes an actuating and locking member 238 pivotally connected to the intermediate latch member 228 via the second pivot pin 234 to allow the actuating and locking member 238 to pivot relative to the intermediate latch member 228. In constructions where the second pivot pin 234 is press fit to the intermediate latch member 228, the actuating and locking member 238 pivots relative to the second pivot pin 234 and the intermediate latch member 228. In constructions where the second pivot pin 234 is pivotal relative to the intermediate latch member 228, the second pivot pin 234 can be press fit to the actuating and locking member 238 to prevent rotation therebetween or the actuating and locking member 238 can be pivotal relative to the second pivot pin 234. In both instances, the actuating and locking member 238 is pivotal relative to the intermediate latch member 228. The actuating and locking member 238 includes an actuating end 190′ and a hook member 180′. The actuating end 190′ is actuatable by a user to move the latch 170′ between the engaged and disengaged positions in order to move the cover 95′ between the attached and detached positions, respectively. The hook member 180′ is selectively engageable with a protrusion 240 of the cover 95′. The hook member 180′ is engageable with the protrusion 240 when the latch 170′ is in the engaged position to attach the cover 95′ to the housing 40′ and is disengaged from the protrusion 240 when the latch 170′ is in the disengaged position to detach the cover 95′.

To attach the cover 95′ to the housing 40′, the rotatable pin 220 is engaged with the hook member 155′ and the cover 95′ is rotated toward the housing 40′ about axis B-B and into engagement with the housing 40′. The latch 170′ is then used to complete attachment of the cover 95′ to the housing 40′. The hook member 180′ is engaged with the protrusion 240 on the cover 95′. The actuating end 190′ is then biased toward the housing 40′. Biasing of the actuating and locking member 238 toward the housing 40′ biases the second pivot pin 234 against the biasing members 232. Sufficient biasing of the member 238 causes the biasing members 232 to compress and the second pivot pin 234 to slide or translate within the second set of apertures 236 toward the housing 40′. Compression of the biasing members 232 and translation of the second pivot pin 234 toward the housing 40′ allows the actuating and locking member 238 to further rotate toward the housing 40′. The latch 170′ is similar to an over-center biasing member in that the latch 170′ is biased toward the disengaged position when the latch 170′ is not rotated past a certain over-center point and is biased toward the engaged position once the latch 170′ is rotated past the certain over-center point. When the latch 170′ is rotated just past the over-center point, the second pivot pin 234 begins to translate away from the housing 40′ (opposite to the first direction of translation), thereby allowing the biasing members 232 to uncompress. The uncompressing of the biasing members 232 biases the latch 170′ toward the engaged position to attach the cover 95′ to the housing 40′.

To remove the cover 95′ from the housing 40′, a user moves the actuating end 190′ away from the housing 40′ to pivot the actuating and locking member 238 in a direction opposite to the direction for attaching the cover 95′. Moving the member 238 in such a direction causes the second pivot pin 234 to translate toward the housing 40′ and compress the biasing members 232. Once the member 238 has been sufficiently rotated past the over-center point, the second pivot pin 234 begins to translate away from the housing 40′ and allows the biasing members 232 to uncompress, thereby moving the latch 170′ toward the disengaged position. The hook member 180′ is then disengageable from the protrusion 240 and the cover 95′ is pivotal away from the housing 40′ about the rotatable pin 220 and axis B-B. The cover 95′ is then removable from the housing 40′.

When the cover 95′ is removed from the housing 40′, an operator can empty the debris or chips, produced during operation, from the cover 95′ and/or can change the saw blade 15′ if the saw blade 15′ is worn out or if a different type of saw blade 15′ is necessary for sawing operations. The cover 95′ is re-attachable to the housing 40′ in a manner similar to the cover 95′ attaching manner discussed above.

An operator may forget to reattach the cover 95′ or may want to operate the saw 10′ without the cover 95′ attached to the housing 40′. The inner cover 200′ covers the teeth 20′ on the upper portion of the saw blade 15′ when the cover 95′ is removed in order to inhibit engagement between an object, such as, for example, an operator's hand, etc., and the teeth 20′ of the saw blade 15′. The cover 200′ is especially useful in instances where an operator may want to operate the saw 10′ without the cover 95′ attached to the housing 40′. In such instances, the rotating teeth 20′ on the upper portion of the blade 15′ are not exposed, thereby increasing the overall safety of the saw 10′.

Although the invention has been described in detail with reference to certain preferred embodiments, variations and modifications exist within the scope and spirit of one or more aspects of the invention as described and defined in the claims.

We claim:

1. A saw comprising:
a housing;
a motor supported by the housing and operable to drive a saw blade;
a cover selectively connectable to the housing, the cover at least partially covering the saw blade when the cover is connected to the housing; and
a quick-locking member connected to one of the housing and the cover and engageable with the other of the housing and the cover to selectively lock the cover to the housing without the use of tools.

2. The saw of claim 1, wherein the quick-locking member is connected to the housing and is engageable with the cover.

3. The saw of claim 2, wherein the quick-locking member has a first position, in which the quick-locking member engages the cover to lock the cover to the housing, and a second position, in which the quick-locking member is disengaged from the cover and the cover is not locked to the housing.

4. The saw of claim 3, wherein the quick-locking member is pivotable between the first position and the second position.

5. The saw of claim 3, further comprising a spring engageable with the quick-locking member to releasably retain the quick-locking member in the first position.

6. The saw of claim 2, wherein the cover defines a recess, the quick-locking member including a locking portion engageable with the recess to lock the cover to the housing.

7. The saw of claim 1, wherein the cover at least partially covers an upper portion of the saw blade.

8. The saw of claim 1, wherein the quick-locking member is a latch.

9. The saw of claim 1, wherein the quick-locking member includes an over-center latch.

10. The saw of claim 1, wherein the housing defines a handle portion gripable by a user, the quick-locking member being connected to the housing near the handle portion.

11. The saw of claim 1, further comprising a second locking assembly cooperating with the quick-locking member to selectively lock the cover to the housing.

12. The saw of claim 11, wherein the housing includes a hook member, the cover engaging the hook member at a first end of the cover and the quick-locking member engaging the cover at a second end of the cover to connect the cover to the housing.

13. The saw of claim 12, wherein the cover includes a ledge engageable with the hook member.

14. The saw of claim 12, wherein the cover includes a pin engageable with the hook member.

15. The saw of claim 1, wherein the quick-locking member includes a first member connected to the housing, a second member connected to the first member and pivotable relative to the first member, and a third member connected to the second member and pivotable relative to the second member, the third member being engageable with the cover to selectively lock the cover to the housing.

16. The saw of claim 15, wherein the third member is engageable by a user to move the third member into and out of engagement with the cover to lock the cover to and unlock the cover from, respectively, the housing.

17. The saw of claim 1, wherein the cover is a first cover, and wherein the saw further comprises a second cover connected to the housing and disposed between the saw blade and the first cover when the first cover is connected to the housing, the second cover at least partially covering the saw blade when the first cover is both connected to and disconnected from the housing.

18. The saw of claim 1, wherein the cover defines a receptacle therein operable to hold fragments of a work piece upon which the saw blade is performing work, fragments being moved into the receptacle by the saw blade as the saw blade rotates during operation.

19. The saw of claim 1, wherein the saw is a circular saw.

20. The saw of claim 1, further comprising a shoe plate connected to the housing and engageable with a surface of a workpiece to support the saw upon the workpiece, the cover substantially covering the portion of the saw blade above the shoe plate.

21. A method of disassembling a saw, the saw including a housing, a motor supported by the housing and operable to drive a saw blade, a cover connectable to the housing and at least partially covering the saw blade when the cover is connected to the housing, and a locking member connected to one of the housing and the cover and engageable with the other of the housing and the cover to selectively lock the cover to the housing, the method comprising the acts of:
moving the locking member from a first position, in which the locking member engages the one of the housing and the cover to lock the cover to the housing, to a second position, in which the cover is not locked to the housing, without the use of tools; and
removing the cover from the housing to at least partially uncover the saw blade.

22. A saw comprising:
a housing;
a motor supported by the housing and operable to drive a saw blade;
a first cover connected to the housing, the first cover at least partially covering the saw blade; and
a second cover selectively connectable to the housing, the second cover, when connected to the housing, at least partially covering the first cover and at least partially covering the saw blade.

23. The saw of claim 22, wherein the first cover at least partially covers the saw blade when the second cover is not connected to the housing.

24. The saw of claim 22, wherein the first cover is disposed between the saw blade and the second cover when the second cover is connected to the housing.

25. The saw of claim 22, wherein the first cover at least partially covers an upper portion of the saw blade and the second cover at least partially covers the first cover and at least partially covers the upper portion of the saw blade when the second cover is connected to the housing.

26. The saw of claim 22, wherein the saw blade includes a plurality of teeth, the first cover covering at least some of the plurality of teeth positioned on an upper portion of the saw blade.

27. The saw of claim 22, further comprising a shoe plate connected to the housing and engageable with a surface of a workpiece to support the saw upon the workpiece, and wherein the saw blade includes a plurality of teeth, the first cover substantially covering the teeth on the portion of the saw blade above the shoe plate.

28. The saw of claim 22, wherein the first cover is semicircular in shape.

29. The saw of claim 22, wherein the second cover defines a cavity for receiving fragments from a work piece upon which the saw blade operates.

30. The saw of claim 29, wherein the housing and the first cover cooperate to define a slot, and wherein the fragments pass through the slot to enter the cavity.

31. The saw of claim 30, wherein one of the housing and the first cover include a tab operable to deflect the fragments into the cavity.

32. The saw of claim 31, wherein the tab is disposed at an end of the slot.

33. The saw of claim 22, wherein the second cover completely covers the first cover when the second cover is connected to the housing.

34. The saw of claim 22, wherein the saw is a circular saw.

35. The saw of claim 22, further comprising a shoe plate connected to the housing and engageable with a surface of a workpiece to support the saw upon the workpiece, the second cover substantially covering the first cover and the portion of the saw blade above the shoe plate.

36. The saw of claim 22, further comprising a quick-locking member connected to one of the housing and the second cover and engageable with the other of the housing and the second cover to selectively lock the second cover to the housing without the use of tools.

37. The saw of claim 36, wherein the quick-locking member is a latch.

38. The saw of claim 36, wherein the quick-locking member includes an over-center latch.

39. A saw comprising:
a housing;
a motor supported by the housing and operable to drive a saw blade;
a cover selectively connectable to the housing, the cover at least partially covering the saw blade when the cover is connected to the housing; and
a quick-locking member operable to releasably lock the cover to the housing.

40. The saw of claim 39, wherein the quick-locking member is connected to one of the housing and the cover and is engageable with the other of the housing and the cover to releasably lock the cover to the housing.

41. The saw of claim 39, wherein the quick locking member is engageable between the housing and the cover.

42. The saw of claim 39, wherein the quick-locking member is a latch and the cover defines a recess, the latch being engageable with the recess to lock the cover to the housing.

43. The saw of claim 39, wherein the quick-locking member is operable to releasably lock the cover to the housing without the use of tools.
